(19) United States
(12) Patent Application Publication
(10) Pub. No.: US 2022/0192116 A1
(43) Pub. Date: Jun. 23, 2022

(54) EQUIPMENT AND PROCESS FOR PLANT NUTRITION THROUGH THE AIR

(71) Applicant: Mankaew MUANCHART, Muang Surin (TH)

(72) Inventor: Mankaew MUANCHART, Muang Surin (TH)

(21) Appl. No.: 17/605,973

(22) PCT Filed: Jan. 29, 2020
(86) PCT No.: PCT/TH2020/000004

§ 371 Date: Oct. 22, 2021

(30) Foreign Application Priority Data
Apr. 22, 2019 (TH) 1901002389

(51) Int. Cl. A01G 31/02

(52) U.S. Cl. CPC A01G 31/02

(57) ABSTRACT

Equipment and process for plant nutrition through the air is mixed between aeroponics system and fogponics system. That injects plant nutrition through rhythmic aeroponics system with automatic control system. Allow plants to receive different sized nutrients at the same time and consistently, combined with colloid plant nutrition through the fogponics system. According to the present invention, the development to reduce energy and resources in cultivation and reduce labor in agro-industry.

### TECHNICAL FIELD

The present invention relates to biotechnology, equipment and processes, in particular plant nutrition.

### BACKGROUND

Plant nutrition is divided into 3 categories hereinafter solid, liquid and air. Solids are soiled crops which is the original crop of humankind. Plant nutrients are solid in the soil and use watering methods to achieve slight nutrients that cause the roots of plants to absorb those nutrients. Later, the problem is unequal soil fertility and soil deterioration problems and problems of plant epidemics that come with soil. Therefore, the development of plant nutrition through liquid is modeled after observing the nature of the plants that float in the water source and able to grow well. Later, the hydroponic plants develop by soaking the roots of the plants with water and using the nutrients or minerals necessary for the growth to dissolve the water. That find the problem is the use of large amounts of water. The problems of wasting resources is a constant experiment to reduce the amount of water. And the development of plant nutrition through the air by hanging in the air and spray water that mixed with plant nutrition through the air up to the roots of the plants. The result is in the growing aeroponics. Later, the size of the water mist has been improved to allow for longer floating in the air that resulting in the cultivation of fogponics.

Patent number WO/2018/172947 reveals the automatic plant nutrition control equipment for hydroponic and aeroponic to solve labor problems in cultivation. That is a device can be used for both types of crops. That is an example of how to use automation in hydroponic and aeroponic cultivation systems.

Patent number WO/2017/217941 reveals plant closed systems by providing fogponics in plant nutrition systems that control the environment, such as lighting, air and farmland that solve vertical cropping problems by making a tower-shaped pot (Tower pot) with a box for hanging the roots of plants into the pot. And release steam solution through plant nutrients

Definition of aeroponics from Wikipedia. (Wikipedia.org) explains the history, definitions, and phases of aeroponics cultivation that including of the size of the solution. The size of solution is 20 to 50 microns, which is different from the fogponics has smaller particle size.

Patent number CN107493874, reveals the process of applying cultivation system with drip irrigation system and light system and the color ratio of light that affects the growth of plants and the relationship between duration and amount of water droplets given to plants. That is to save cultivation resources and increase the quality of the produce and reduce the cultivation period.

To determine the amount of time to give nutrients to plants can be found in present agricultural industry to reduce resources and energy in cultivation, but it is also a development based on solid nutrition but there is no feeding timing found in the air nutrition. Because the roots suspended in the air without moisture will cause the plants to eventually die.

The reduction of plant nutrition duration is usually done through the lighting of plants so that the plants can understand the day cycle that makes plants grow faster. No plant growth is accelerated through the nutrition system alone and coupled with general lighting or natural light.

The problem of agro-industry is labor shortage. There are automatic assist devices entered into the cultivation system especially the periodic suspension of plant nutrition throughout the cultivation period. The equipment is to replace human labor therefore the most suitable. Therefore, the aforementioned methods can be used in agro-industrial systems.

### SUMMARY OF INVENTION

The purpose of this invention is to create a cultivation process. An integrated plant nutrition program between aeroponic system and fogponics system, which has different plant nutrient dimensions. The source of nutrients comes from different dispensers and bring automatic systems to help the cultivation to shorten the planting time and reduce energy resources and farming resources and can be used in agriculture industry.

Different from the patent number WO/2017/217941 and defining aeroponics from Wikipedia (Wikipedia.org) is that although this method of cultivation based on invention. That is a combination of nutrients for plants with different results. Because both methods of cultivation cannot shorten cultivation time.

Unlike the patent number CN107493874, it doesn't have to take the light method. Spectrum of specific lighting in cultivation can reduce the planting period.

The technique of invention is the alternation of plant feeding between the aeroponics system and the fogponics system. Although both plant nutrients through the air are differences in levels of particle by combining both methods with a spray of plant nutrients from the dispenser of the aero-photonic system in a rhythm.

### BRIEF DESCRIPTION OF THE DRAWINGS

FIG. 1 is an overview explaining equipment and processes for plant nutrition through the air.

FIG. 2 is an automated control system operation of a solenoid valve (6).

### DETAILED DESCRIPTION

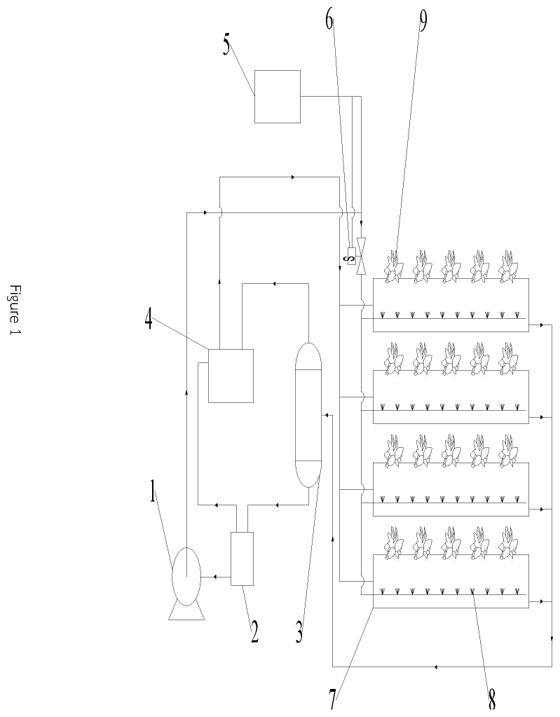

The process of feeding plant nutrients through air, as in FIG. 1, can be described as follows: Pump (1) receives liquid nutrients from the solution tank (2). Liquid nutrients add pressure by the water pump (1) causes nutrients to flow through the pipes to the solenoid valve (6), which controls the opening and closing of the liquid that goes into the pipes inside the pots (8) each pot, when the computer controls (5) send signal at the solenoid valve (6) to open nutrients that flow into the inner pot with water spray nozzle (12) installed as well. From the beginning of the pot to the end of the pot spray nozzles (12) will spray the droplets of nutrients spread out around. The droplets will be larger than the mist and rise up to cling to the roots of plant (11). Water droplets do not stick to the roots of the plant will fall down the bottom of the pot together into liquid again. And droplets flows out through the pipes that installed within the pot at the lowest point compared to other pipelines then the liquid form nutrients will flow along the pipe outside the pot back into the separation tank of liquid and colloidal gas (3) which acts as a separator liquid and gas. In which the liquid from the separation tank of liquid and colloidal gas (3) will flow along the pipe to the solution tank (2).

While providing liquid nutrients, the system will start to provide nutrients in the form of colloidal gas at the same time. That can be explained as follows the colloid sources (4) receive liquid nutrients from the solution tanks (2). Liquid nutrients become colloidal gas at the colloid source (4), then the colloidal gas will float into the pipes to the pot (8) until the density is stable. The colloid support will float in pots and stick to the roots of plants. The remaining power will condense down the bottom of the pot together into liquid. And colloid flow out the pipe that installed inside the pot at the lowest point. That compared to other pipes have nutrients in the form of liquid will flow out of the pipe outside the pot back into the separation tank of liquid and colloidal gas (3) with some colloids floating out through the pipe as well. When the liquid and colloidal nutrients enter the separation tank of liquid and colloidal gas (3), inside the tank there will be a trap as solid sheet. That tilt at an angle from 10 to 89 degrees in order to allow the colloid to float on or cling to the trap. Then will fall to the bottom combine into liquid and there will be some colloid that is fine colloid or fine mist that is about 4 microns to gradually smaller at the nano level. That will float along the top tube to the colloid source (4) again, the liquid below of the separation tank of liquid and colloidal gas (3) which will flow along the pipe to the solution tank (2) to proceed to the next cycle.

In the control of the automatic control system of the computer (5), which controls the solenoid valve (6) has a specific characteristic, that is, it will be adjusted according to the type of crop cultivated. From the experiment of growing plants in an environmental control system affects the growth of plants. Form of providing nutrition in the air through systems such as aeroponics and fogponics. The liquid nutrition systems such as hydroponic and solid-liquid systems such as soil cultivation. It is found that alternating cultivation methods provide nutrients for plants to grow better than any type of cultivation, for example, in crop cultivation in soil with drip irrigation. Which is an alternate method for providing nutrients between solids and liquids. In the cultivation using soil with spray water. That is an alternate method of providing nutrients between solids and air which can be seen that there are differences in both methods and sizes of nutrients.

According to the present invention is to advance development comes from the experimentation of alternating plant nutrition by switching between the aeroponics and fogponics systems. Which is the same way to plant nutrition through the air. But that has different dimensions in which aeroponics form water droplets or mist. The fogponics are vapor that is a solution or a smaller mist in the micron to nanometer level. By experimenting with multiple plant families in other controlled environments, the same way found feeding time and the size of nutrients that affects the plant growth period. In addition, the amount of nutrients for plants of different magnitudes affects the growth of plants, especially the nutrition provided by aeroponic system with a large size of the powers and systems. Smaller foxes with the method of determining the duration of water spray of the aeroponics system, the cultivation period will be shorter compared to cultivation with other forms of nutrition.

To determine the amount of time the nutrient is sprayed through the spray nozzles (12) that determined from the results of each type of plant repeatedly, to find the best distance for determining the relative humidity within the pot (8). Because plants will accelerate the absorption of nutrients when in the relative humidity range critical or critical range. That remember the growth is about to decrease. From the experiment found that add moisture will helps the plants to absorb nutrients more quickly. After that, the absorption value will return to be stable. Therefore, when there is sufficient supply of nutrition between and not enough constantly cultivating will cause the plant to accelerate absorption in rhythm. The result in shorter crop duration compared to the standard size of plants in the harvest period, that is to harvest faster in a shorter time period.

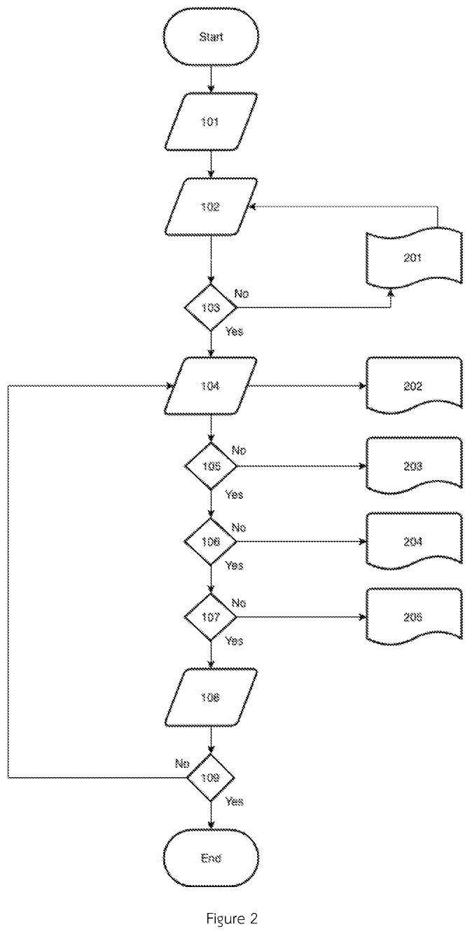

The procedure of the automatic control system of the solenoid valve control device or the computer control (5), as FIG. 2, can be described as follows. To send the command to start working (101), the system will classify plants (102) when the system can determine family belongs to family. The data will be selected from the classification group that is used in pots such as green leafy plants and flowering plants, etc. Then it will examine the species in more detail by checking the species of plants such as gladiolus, rose type, for example. The species will be divided into aeroponics timing using the time classification procedure (103), which contains an array of periodic data to match with species of plants. If the information doesn't match, the system will add and schedule the operation (201) and then loop back into (103) again. If the data matches, the pump will be ordered (104) while the order at (104) will show the count time. To reverse operation (202) after ordering the water pump (104) will spray the nutrient mist and set the spray opening period (105) and then check if the timing is correct. If not, go to display of work situations and notifications (203) but if yes, it will start the closing period (106) and then check if the timing is correct. If not, go to display of work situations and notifications (204) but if yes, it will start the production schedule (107) and then check if the schedule is correct. If not, go to display of work situations and notifications (205) but if yes, will report the work status (108) by reporting the work status be set to report in intervals. And will check if the work has been completed at step (109), which will loop back to check steps (104), (105), (106), (107) and (108) respectively until the end doing work. Then send the command to the exit procedure (109).

The following will reveal the equipment and processes for plant nutrition through the air, consisting of;

Colloid source (4) serves to change the solution status into a colloid state. The aerosol with a suitable size of 3 to 7 microns. The type of colloid source (4) is the ultrasonic nozzle. That emits higher frequencies than sound frequencies with a frequency band from 1 to 6 MHz because it will cause the colloids to have the right temperature;

Spray nozzles (12) change the solution to a solution spray. That shaped like water droplets size of 7 microns or more by spraying water around causing water droplets to attach to the roots of plants (11);

Solenoid valve (6) that opens and closes the inlet of the solution in a liquid form. The spray nozzles (12) have a special feature, which is an automatic control system. From the computer (5) send commands to turn on and off at intermittent intervals, with working procedures depending on the type of plants cultivated.

The present invention has special characteristics that are suitable for the following crops. That is,

1. Water pump (1) serves to increase the pressure of the liquid to spread to various pipes within the system thoroughly increasing pressure depends on the number of plants you want to cultivate.

2. Solution tank (2) responsible for collecting solutions is strong, rust-proof and resistant to corrosion, easy to clean, corrosion resistant and suitable materials include polyvinyl chloride, polyethylene or polypropylene, stainless steel grade 316L. The most suitable material is stainless steel grade 316L.

3. the separation tank of liquid and colloidal gas (3) have a special characteristic, that is, there will be traps in sheets or grid or metal that is a picture made from materials that are solid state. That tilted at an angle from 10 to 89 degrees to one wall of the tank. And that have at least 1 trap to allow the colloid to float on or cling to the trap and form a liquid that falls to the bottom of the separation tank. At the bottom of the separation tank there is a separation pipe to bring the solution to the solution tank (2). The area above the separation pipe has separation pipes to bring the colloid to the colloidal source (4). The suitable materials are polyvinyl chloride, polyethylene or polypropylene, stainless steel grade 316L. The most suitable material is stainless steel grade 316L.

4. Pot (8) There are 2 suitable forms which are;

Style 1: Look like a pipe melted into one piece. Inside the pipe is placed a spray nozzle (12) installed distance apart at the top of the pot there are compartments for plants. In which the plant's roots are suspended in the pot and manufactured from suitable materials as follows Polyvinyl chloride, polyethylene, polypropylene or stainless steel. The form is suitable for growing plants that spread the surrounding leaves, such as the family Lactuca (Lactuca sativa), the family Passeiflora foetida Linn. etc.

Style 2: Comprising more types of devices, assembled into pots, which are containers and lids. The container has the following characteristics

The container consists of a wall covering the top, airy and the bottom is a floor attached to the wall. Forming a shape that can contain liquid inside at the side of the wall, there are at least 3 holes or cavities, which are placed at the bottom of the wall to measure the height of the hole as follows. Point 1 is the lowest level when measured from the mouth of the container. But one level above the ground, that is responsible for transferring liquid from condensation, mist, and condensation of gases inside the container, which fall into the bottom of the container. When accumulated to the height of point 1 of these pipes will flow out the pipes attached to point 1 flow together into the separation tank of liquid and colloidal gas (3) at the destination of the pipe.

Point 2 is at the higher level from point 1 is a hollow hole. There will be a hose or pipe passing through point 2. The pipe or hose will have a spray nozzle (12) installed. The liquid from this pipe will enter the spray nozzle (12) into a small mist with the force of the sprayer sent the droplets up to the island of the floating plant hanging. The water droplets do not adhere to the plant roots will fall below combined into liquid at the bottom of the container.

Point 3 is a channel that welded to the pipe or has a hole in the shape of a pipe or tube inserted into which the pipe or the hose will bring colloid gas from the colloid source (4) to float along the pipe through the pot (8) until the gas density is constant. At the appropriate relative humidity for each plant less colloidal gas will come to the pot until finally brought in. That will be a temporary condition only because plants absorb nutrients from the droplets of nutrients and colloidal gas all the time, so the substance of the substance is lost. That will reduce the density. Then the colloid source (4) will release the colloid as before.

The lid of the container consists of materials that have holes in the roots of the plant passing through, such as hard materials that are punctured or textile or fabric.

Suitable materials are polyvinyl chloride, polyethylene or polypropylene, stainless steel grade 316L, stainless steel grade 304, stainless steel grade 308, softwood and hardwood. The most suitable material able to withstand corrosion, lightweight, cheap, is polyvinyl chloride.

Textile means fibers, yarns, products made of fibers which does not need to be a flat sheet. The suitable textiles are yarns made from nature. Yarns are made from synthetic fibers. The most appropriate textile fibers are natural yarns, especially linen and hemp, because they are plant fibers, like the roots of plants. That is suitable for harvesting plants that require roots for cooking, such as celery, coriander, etc. Because it is safe in the event of cleaning or mixed with the roots of plants. The cultivation method using textile containers will stretch the yarns together. Without knitting or weaving, such as fabric, in which the seeds are placed or hung on the thread that is stretched which can be done in both forms using the seeds to place or sprinkle or use a small pot to put the seedlings. Or seeds into the thread and insert the threads into the pot. To make the pot float in the air.

Fabric is a flat sheet that manufactured from slurry, fibers, yarns using molded polymer materials. In which there must be a space for the plant roots to penetrate the fabric suitable fabrics include fabrics made from natural fibers that made from synthetic fibers and manufactured from mixed fibers. The most suitable fabric is made from natural fibers such as cotton, linen, hemp fabric for the following reasons. Cotton and linen are an inexpensive material that is easy to find and easy to clean. The flexible hemp fabric is strong and durable resulting in longer service life than other types of fabrics. And that has a low thermal conductivity and a higher porosity than other types of fabric. That allow the air to pass better resulting in more oxygen. In which oxygen affects the growth of plants, i.e. reducing plant stress. The stress of the plants affects the frame of the plant, especially the leaves. Therefore the plants cultivated with hemp cloth container lid. There is less frame and the leaves feel soft than plants from plants grown by other materials. And because of the hemp fabric have a low thermal conductivity, low flame rate and has been developed for insulation. Therefore, the hemp fabric has a container lid as this invention will better prevent temperature transfer between pots and the outside atmosphere. The temperature is suitable for the absorption of the roots of plants is between 20 to 30 degrees Celsius, but the temperature of the leaves depends on the type of plant, such as temperate plants in the range of 15 to 20 degrees Celsius, etc.

The results of the experiment with the cultivation of plants through the equipment and the process of feeding the plants through the air. According to the present invention, when compared to feeding the nutrients through other statuses as shown below.

Table comparing the duration of cultivation for each step of each method of cultivation by providing nutrients through different statuses. By holding the standard weight in the harvest, ending the harvest cycle divide into phases as follows

Phase 1 is to plant seeds from seed to germinate with twin cotyledons, etc. That are soft and rise above the ground in the range of 1 to 4 cm. The trunk is straight and strong.
Phase 2 is a seedling to grow, etc. The seedlings with 3-4 true leaves, stems erect and strong.
Phase 3 is the seedlings growing until reaching the standard weight of the harvest.
As shown in the table using the age of Mizuna (Japanese mustard) as follows

| | Cropping | Hydroponic | Growing | The cultivation |
|---|---|---|---|---|
| | using soil | cropping Or | aromatic plants | of plants in |
| | Or providing | providing | Or providing | accordance with |
| | nutrients through | nutrients through | nutrients through | this artificial |
| phase | solids (day) | fluids (day) | the air (day) | aspect (day) |
| Phase 1 | 10-12 | 9-10 | 9-10 | 4-7 |
| phase 2 | 30-40 | 10-15 | 10-15 | 5-10 |
| phase 3 | 20-30 | 15-20 | 12-20 | 10-15 |

By specifying the duration of spraying from the spray nozzles (12) is 5 minutes.

It can be seen that with the method of crop cultivation through the process of plant nutrition through the air. According to this invention reduce the stage of plant growth at every step, especially that compared with the use of soil-grown crops, Phase 1 can reduce the number of days by 54 percent. Phase 2 can reduce the number of days to 79 percent. Phase 3 can reduce the number of days by 54 percent by using the mean values of each period, to calculate.

1. Equipment and process for plant nutrition through the air, the process comprising:
Colloid source (4) serves to change the state of the solution into the liquid aerosol state wherein a suitable size of 3 to 7 microns;
Spray nozzles (12) change the solution to a solution spray. That shaped like water droplets size of 7 microns or more by spraying water around causing water droplets to attach to the roots of plants (11);
Solenoid valve (6) that opens and closes the inlet of the solution in a liquid form before going into the spray nozzles (12) which has the characterize is an automatic control system and from the computer (5), that send commands to turn on and off at intermittent intervals, with working procedures depending on the type of plants cultivated.

2. Equipment and process for plant nutrition through the air according to claim 1, wherein the solenoid valve (6) serves to open and close the inlet of the solution in a liquid form before going into the spray nozzles (12) that have a special feature, which is an automatic control system from the computer (5), that send commands to turn on and off periodically alternately, with work procedures depending on the type of plants cultivated to send the command to start working (101), and the system will classify plants (102), when the system can determine family belongs to which family, the data will be selected from the classification group that is used in pots such as green leafy plants, flowering plants, that will examine the species in more detail by checking the species of plants such as gladiolus rose type, then it will be divided into aeroponics timing using the time classification procedure (103), which contains an array of periodic data to match with species of plants. If the information doesn't match, the system will add and schedule the operation (201) and then loop back into (103) again. If the data matches, the pump will be ordered (104) while the order at (104) will show the count time. To reverse operation (202) after ordering the water pump (104) will spray the nutrient mist and set the spray opening period (105) and then check if the timing is correct. If not, go to display of work situations and notifications (203). But if yes, that will start the closing period (106) and then check if the timing is correct. If not, go to display of work situations and notifications (204). But if yes, that will start the production schedule (107) and then check if the schedule is correct. If not, go to performance status display and notification (205). If yes, that will report the work status (108). The status report can be set to report periodically. Or as required, that will check if the work has been completed at step (109), which will loop back to check steps (104), (105), (106), (107) and (108) respectively until the end doing work. Then send the command to the exit procedure (109).

3. Equipment and process for plant nutrition through the air according to claim 1, wherein the suitable type of colloid source (4) is the ultrasonic frequency emitter which emits higher frequency than the sound frequency. With a frequency band from 1 to 6 MHz because it will cause the colloids to have the right temperature.

4. Equipment and process for plant nutrition through the air according to claim 1, wherein the providing plant nutrition through the air through spray nozzles (12) that have a working process. To explain as follows. Water pump (1) receive liquid nutrients from the solution tank (2). Liquid nutrients will be boosted by water pump (1) causing nutrients to flow through the pipes to solids. The solenoid valve (6) which controls the opening and closing of the liquid that goes into the pipes inside each pot (8). When the computer controls (5) send signal to the solenoid valve (6) to open, the nutrients will flows into the inner tube of the stream. With a spray nozzle (12) installed periodically, From the beginning of the pot to the end of the spray nozzles (12) will spray the droplets of nutrients spread out around. The droplets will be larger than the mist and rise up to cling to the roots of plants (11). Water droplets do not stick to the roots of the plant will fall down the bottom of the pot together into liquid again and flow out the pipe installed inside the pot at the lowest point. That compared to other pipes that have nutrients in the form of liquid will flow out of the pipe outside the pot back into the separation tank of liquid and colloidal gas (3). The function of separating liquid and gas in which the liquid from the separation tank of liquid and colloidal gas (3) will flow along the pipe to the solution tank (2).

5. Equipment and process for plant nutrition through the air according to claim 1, wherein the feeding of plant nutrients through air through the conversion of liquids to colloids with colloid source (4) there is a work process. Colloid source (4) receive liquid nutrients from the solution tank (2). Liquid nutrients will become colloidal gas at the colloid source (4), then the colloidal gas will float into the pipes through the pot (8) until the density is stable. The colloid will float in pots and stick to the roots of plants. The remaining power will condense down the bottom of the pot together into liquid. And flow out the pipe installed inside the pot at the lowest point. That compared to other pipes that have nutrients in the form of liquid will flow out of the pipe outside the pot back into the separation tank of liquid and colloidal gas (3). Some colloids float out through the pipe as well when the liquid and colloidal nutrients enter the separation tank of liquid and colloidal gas (3), inside the tank there will be a trap as solid sheet. That tilt at an angle from 10 to 89 degrees in order to allow the colloid to float on or cling to the trap. Then that will fall to the bottom and combined into liquid. And there will be some colloid that is fine colloid or fine mist that is about 4 microns to gradually smaller at the nano level will float along the top tube to the colloid source (4) again, the liquid below of the separation tank of liquid and colloidal gas (3) will flow along the pipe to the solution tank (2) to proceed to the next cycle.

6. Equipment and process for plant nutrition through the air according to claim 4, wherein the solution tank (2) responsible for collecting solutions. It is strong, rust-proof, resistant to corrosion and easy to clean corrosion resistant. The suitable materials include polyvinyl chloride, polyethylene or polypropylene, stainless steel grade 316L.

7. Equipment and process for plant nutrition through the air according to claim 4, wherein the separation tank of liquid and colloidal gas (3) have a special characteristic that for some trap in sheets or grid or metal in shape, to make from solid state materials tilt at an angle from 10 to 89 degrees to one wall of the tank. And that have at least 1 trap to allow the colloid to float on or cling to the trap. And form a liquid that falls to the bottom of the separation tank at the bottom of the separation tank. There is a separation pipe to bring the solution to the solution tank (2). The area above the separation pipe has the isolation pipes for bringing the colloid to the colloid source (4).

8. Equipment and process for plant nutrition through the air according to claim 7, where the separation tank of liquid and colloidal gas (3) have suitable materials which are polyvinyl chloride, polyethylene or polypropylene, stainless steel grade 316L.

9. Equipment and process for plant nutrition through the air according to claim 4, wherein the pot (8) type 1 looks like a single piece pipe inside the pipe is placed a spray nozzle (12) installed periodically apart. At the top of the pot there are compartments for plants. In which the plant's roots are suspended in the pot and manufactured from suitable materials as follows polyvinyl chloride, polyethylene, polypropylene or stainless steel.

10. Equipment and process for plant nutrition through the air according to claim 4, wherein the pot (8) type 2 consists of at least two devices which are container and lid. The container has a special feature, the container consists of a wall covering the top, airy and the bottom is the floor next to the wall. Formed into a shape that can contain liquid inside on the side of the wall, there are at least 3 holes or cavities that placed at the height of the hole.

11. Equipment and processes for plant nutrition through the air according to claim 10 wherein the hole or hole of the 3-point wall has the following characteristics; Point 1 is the lowest level when measured from the mouth of the container. But one level above the ground. It is responsible for transferring liquid from condensation, mist, and condensation of gases inside the container, which fall into the bottom of the container. When accumulated to the height of point 1 of these pipes will flow out the pipes attached to point 1 flow together into the separation tank of liquid and colloidal gas (3) at the destination of the pipe. Point 2 is at the higher level, from point 1 is a hollow hole. That will have a pipe or pipe pass through this point 2 at the pipe or the hose has a spray nozzle (12) installed. The liquid from this pipe enters the spray nozzle (12) into a small mist with the force of the spray nozzle to spray up the top to the roots of hanging floating plants. The water droplets do not adhere to the plant roots will fall below and combine into liquid at the bottom of the container. Point 3 is a channel. That weld to the pipe or has a hole in the shape of a pipe or tube inserted into. The pipe or the hose will bring colloid gas from the colloid source (4) to float along the pipe to enter the pot (8) until the gas density is constant. At the appropriate relative humidity for each plant that has less colloidal gas will come to the pot until finally brought in, which will be a temporary condition only. Because plants absorb nutrients from the droplets of nutrients and colloidal gas all the time, so the substance is lost. That will reduce the density. Then the colloid source (4) will release the colloid as before.

12. Equipment and process for plant nutrition through the air according to claim 11 wherein the lid consists of materials that have holes in the roots of the plant passing through, such as hard materials that are punctured or textile or fabric.

13. Equipment and process for plant nutrition through air according to claim 12, where the right hard hole punching material is polyvinyl chloride, polyethylene or polypropylene, stainless steel grade 316L, stainless steel grade 304, stainless steel grade 308, softwood or hardwood.

14. Equipment and process for plant nutrition through the air according to claim 12, where textile means fiber, yarn, product made of fiber. That do not need to have the characteristics of a suitable flat sheet, consisting of natural yarn. Yarn is made from synthetic fiber, the most suitable textile fiber is natural yarn, especially linen and hemp.

15. Equipment and process for plant nutrition through the air according to claim 12 wherein fabric has characteristics is a flat sheet, manufactured from slurry, fibers, yarns using polymer forming materials. In which there must be a space for the plant roots to penetrate the fabric. The suitable fabrics include fabrics made from natural fibers made from synthetic fibers and manufactured from mixed fibers. The most suitable fabric is fabric that is made from natural fibers, cotton, linen or hemp.
